(19) United States
(12) Patent Application Publication
(10) Pub. No.: US 2022/0104314 A1
(43) Pub. Date: Mar. 31, 2022

(54) COUPLING BOX HAIRPIN REPLACEMENT FOR HIGH VOLTAGE HEATING ELEMENT

(71) Applicant: WATLOW ELECTRIC MANUFACTURING COMPANY, St. Louis, MO (US)

(72) Inventors: Michael A. JONES, St. Louis, MO (US); Ken GAULKE, St. Louis, MO (US); Jeremy OHSE, St. Louis, MO (US); Roger BRUMMELL, St. Louis, MO (US); Scott H. BOEHMER, St. Louis, MO (US); Jacob LINDLEY, St. Louis, MO (US)

(73) Assignee: WATLOW ELECTRIC MANUFACTURING COMPANY, St. Louis, MO (US)

(21) Appl. No.: 17/486,759

(22) Filed: Sep. 27, 2021

Related U.S. Application Data
(60) Provisional application No. 63/083,854, filed on Sep. 25, 2020.

(51) Int. Cl. H05B 3/44; H05B 3/48; H05B 3/08

(52) U.S. Cl. CPC H05B 3/44; H05B 2203/016; H05B 3/08; H05B 3/48

(57) ABSTRACT

A heater assembly includes a pair of heating sections and a coupling assembly. The heating sections each include a conductive portion. The coupling assembly includes a coupling enclosure and a coupling member disposed inside the coupling enclosure. The conductive portions of the pair of heating sections are connected by the coupling member inside the coupling enclosure.

### CROSS-REFERENCE TO RELATED APPLICATIONS

This application claims priority to and the benefit of U.S. Provisional Patent Application No. 63/083,854, filed Sep. 25, 2020. The disclosure of the above application is incorporated herein by reference in its entirety.

### FIELD

The present disclosure relates to a heater assembly in high voltage applications, and more particularly to a heater assembly having a resistive heating element configured to define one or more turns.

### BACKGROUND

The statements in this section merely provide background information related to the present disclosure and may not constitute prior art.

Conventional resistive heating elements may be arranged to have a serpentine configuration including a plurality of “hairpin” or 180° bends along their lengths in order to provide a higher density of heating elements in an application such as heat exchangers. However, when the resistive heating elements are operating at higher voltages, the dielectric material surrounding the resistive wire or element at the bends can be compromised during manufacturing, reducing the dielectric strength.

These issues with resistive heating elements having hairpin bends, or other non-linear paths, are addressed by the present disclosure.

### SUMMARY

This section provides a general summary of the disclosure and is not a comprehensive disclosure of its full scope or all of its features.

In one form, a heater assembly is provided, which includes a pair of heating sections and a coupling assembly. The heating sections each include a conductive portion. The coupling assembly includes a coupling enclosure and a coupling member disposed inside the coupling enclosure. The conductive portions of the pair of heating sections are connected by the coupling member inside the coupling enclosure.

In other optional features, which may be employed individually or in any combination, the coupling enclosure defines a pair of apertures. The conductive portions are inserted into the pair of apertures to contact the coupling member. The coupling assembly further includes a dielectric material disposed inside the coupling enclosure for electrically insulating the coupling member. The pair of heating sections each include a resistive heating element, a sheath surrounding the resistive heating element, and a first dielectric material disposed inside the sheath. The conductive portion extends from the resistive heating element and is exposed from the sheath and the first dielectric material. The sheaths of the pair of heating sections are welded to the coupling enclosure. A part of the sheaths of each of the pair of heating sections is disposed inside the coupling enclosure. The heater assembly further includes a sealing structure between the sheath of each of the pair of heating sections and the coupling enclosure. In one form, the coupling member is made of a material different from that of the resistive heating elements.

In other variants, the coupling enclosure includes: a housing comprising a proximal end portion and a distal end portion; an element cap disposed at the proximal end portion and having two apertures, each of the two heating sections extending through one of the two apertures; and an end cap secured to the distal end portion of the housing. The element cap is welded to the pair of heating sections to form a sealed interface. The element cap further includes a flange extending from and surrounding each of the two apertures, the flange contacting an adjacent one of the heating sections. The sheath of each of the pair of heating sections is welded to one of the flanges. The housing and the element cap form a single integral part. The conductive portions are welded to the coupling member. The heating sections operate at voltages greater than about 480 volts.

In another form, a heater assembly is provided, which includes two heating sections and a coupling assembly. The heating sections each include a resistive heating element, a sheath surrounding the resistive heating element, a first dielectric material disposed inside the sheath, and a conductive pin extending from the resistive heating element and exposed from the sheath and the first dielectric material. The coupling assembly includes a coupling enclosure, a coupling member disposed inside the coupling enclosure and contacting the conductive pins of the two heating sections, and a second dielectric material disposed inside the coupling enclosure and electrically insulating the coupling member and the conductive pins. The sheaths of the heating sections are welded to the coupling enclosure to form a sealed interface between the heating sections and the coupling enclosure. The two heating sections operate at voltage greater than about 480 volts.

In still another form, a heater assembly is provided, which includes two heating sections and a coupling assembly. The heating sections each include a resistive heating element, a sheath surrounding the resistive heating element, a first dielectric material disposed inside the sheath, and a conductive pin extending from the resistive heating element and exposed from the sheath and the first dielectric material. A pair of tubular dielectric elements are disposed inside the sheath around the conductive pins. A solid dielectric member is placed over the conductive pins. The coupling assembly includes a coupling enclosure, a coupling member disposed inside the coupling enclosure and contacting the conductive pins of the two heating sections, and a third dielectric material disposed inside the coupling enclosure and electrically insulating the coupling member and the conductive pins. The sheaths of the heating sections are welded to the coupling enclosure to form a sealed interface between the heating sections and the coupling enclosure. The two heating sections operate at voltage greater than about 480 volts.

In still another form, a coupling assembly for use in a heater system operating at voltages greater than about 480 volts is provided, which includes a coupling enclosure, a coupling member, and a dielectric material. The coupling enclosure defines a pair of apertures for receiving conductive portions of a pair of heating sections. The coupling member is disposed inside the coupling enclosure for connecting the conductive portions of the pair of heating sections. The dielectric material is disposed inside the coupling enclosure for electrically insulating the coupling member and the conductive portions of the heating sections.

In other optional features, the coupling enclosure includes an element cap defining the apertures. The heating sections are welded to the element cap around the apertures. The coupling assembly further includes a sealing structure between the heating sections and the coupling enclosure along peripheries of the apertures. The coupling member has a plate configuration or a circular bar configuration. The dielectric material surrounds the conductive portions of the heating sections.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a heat exchanger in which a heater assembly constructed in accordance with the teachings of the present disclosure is disposed;

FIG. 1B is a perspective, partial cross-sectional view of an end of the heat exchanger of FIG. 1A;

FIG. 2A a perspective view of a heater assembly including a coupling assembly constructed in accordance with the teachings of the present disclosure;

FIG. 2B is a perspective view of the heater assembly of FIG. 2A with a coupling enclosure of the coupling assembly removed for purposes of clarity;

FIG. 3 is a cross-sectional view of a heating section of the heater assembly of FIG. 2A;

FIG. 4 is a perspective view of a coupling enclosure of a coupling assembly constructed in accordance with the teachings of the present disclosure;

FIG. 5 is a perspective view an element cap of a coupling enclosure of a coupling assembly constructed in accordance with the teachings of the present disclosure;

FIG. 6 is a perspective view of a heater assembly including a coupling assembly constructed in accordance with the teachings of the present disclosure;

FIG. 7 is a perspective view of another form of a heater assembly including a coupling assembly constructed in accordance with the teachings of the present disclosure;

FIG. 8 is a perspective view of still another form of a heater assembly including a coupling assembly constructed in accordance with the teachings of the present disclosure;

FIG. 9 is a cross-sectional view of still another form of a heater assembly including a coupling assembly constructed in accordance with the teachings of the present disclosure;

FIG. 10 is a cross-sectional view of still another form of a heater assembly including a coupling assembly constructed in accordance with the teachings of the present disclosure; and

FIG. 11 is a cross-sectional view of still another form of a heater assembly including a coupling assembly constructed in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

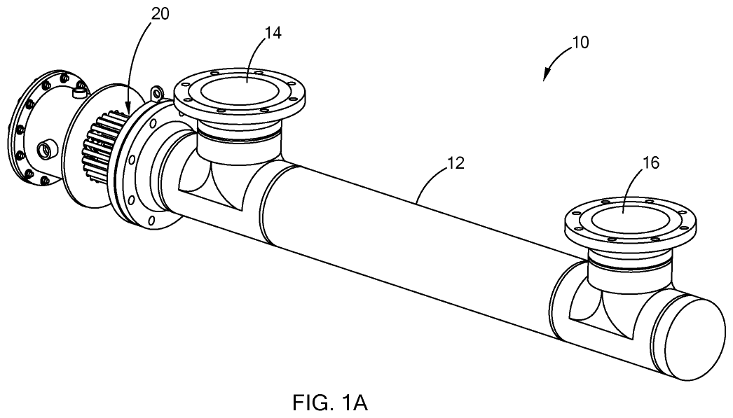

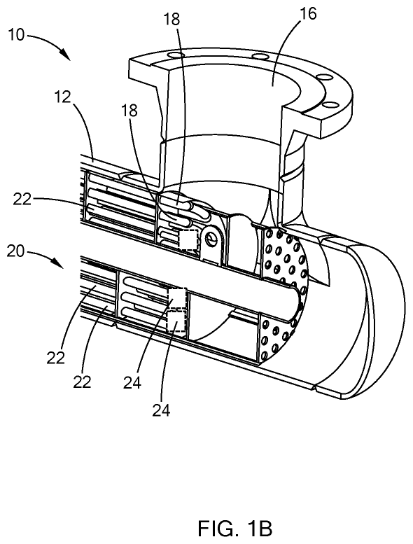

Referring to FIGS. 1A and 1B, a heater assembly 20 constructed in accordance with the teachings of the present disclosure is illustrated. The heater assembly 20 in one form is used for high voltage (e.g., greater than about 480 Volts) applications. One such application is described in U.S. Pat. No. 10,941,988, which is commonly owned with the present application and the contents of which are incorporated by reference in its entirety. In this application, the heater assembly 20 is used in a heat exchanger 10, which generally includes a tubular vessel 12 defining an inlet 14 and an outlet 16, and one or more heater assemblies 20 disposed inside the tubular vessel 12 for heating a fluid flowing into the inlet 14 and exiting the outlet 16.

As clearly shown in FIG. 1B, in one form, the heat exchanger 10 includes one or more heater assemblies 20 including a plurality of heating sections 22 and a plurality of coupling assemblies 24 (schematically shown in dashed rectangular boxes) for connecting the plurality of heating sections 22. To better illustrate the interchangeability of a bend 18 of a typical heater and a coupling assembly 24 of the present disclosure, some of the heating sections 22 are connected by the coupling assemblies 24, whereas some of the heating sections 22 may be connected by the bends 16 of a typical heater without being replaced by the coupling assemblies 24. Alternately, the coupling assemblies 24 may be employed at each end portion where the heating section 22 turns back the other direction. In one form, the heater assembly 20 includes a pair of heating sections 22 connected by a coupling assembly 24. In another form, the heater assembly 20 may include multiple pairs of heating sections 22 connected by a plurality of coupling assemblies 24.

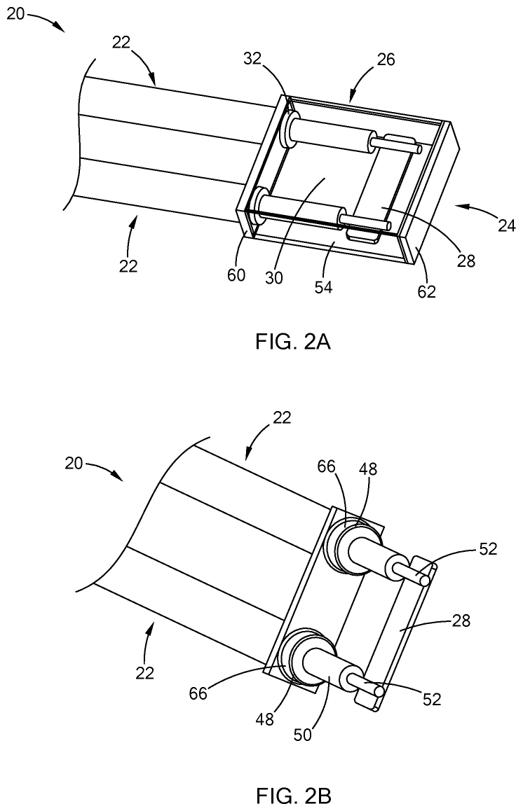

Referring to FIGS. 2A and 2B, in one form, the heater assembly 20 includes a pair of heating sections 22 and a coupling assembly 24 for connecting the pair of heating sections 22. The coupling assembly 24 includes a coupling enclosure 26, a coupling member 28 disposed inside the coupling enclosure 26, and a dielectric material 30 disposed inside the coupling enclosure 26 for embedding and electrically insulating the coupling member 28 and portions of the heating sections 22 connected to the coupling member 28. The coupling enclosure 26 is illustrated in FIG. 2A with transparent surfaces for purposes of clarity to view the components internal to the coupling enclosure 26. In one form, the coupling enclosure 26 may have a box configuration and define a pair of apertures 32 to allow end portions of the pair of the heating sections 22 to be inserted therein.

The pair of heating sections 22 each have opposing ends. One of the opposing ends of each of the heating section 22 is inserted into a corresponding one of the apertures 32 to be connected to the coupling member 28 disposed inside the coupling enclosure 26, and the other one of opposing ends may be connected to a power source or a controller (not shown) to complete an electric circuit. The coupling member 28 is made of electrically conductive material. When more than two heating sections 22 are used, two or more coupling assemblies 24 may be used to connect these heating sections 22 and thus one or more of the heating sections 22 may have both opposing ends connected to an adjacent one of the coupling assemblies 24. The heating sections 22 may be arranged to be parallel to one another or may define an angle depending on needs. In either case, the coupling assembly 24 is used to couple adjacent ends of two heating sections 22, which would otherwise be joined by a 180° “bend” 18 (shown in FIG. 1B) or “hairpin” structure in a typical heater assembly. Therefore, the heating sections 22 and the coupling assemblies 24 are arranged and connected to define a heating assembly with one or more turns or a heating assembly having a serpentine configuration.

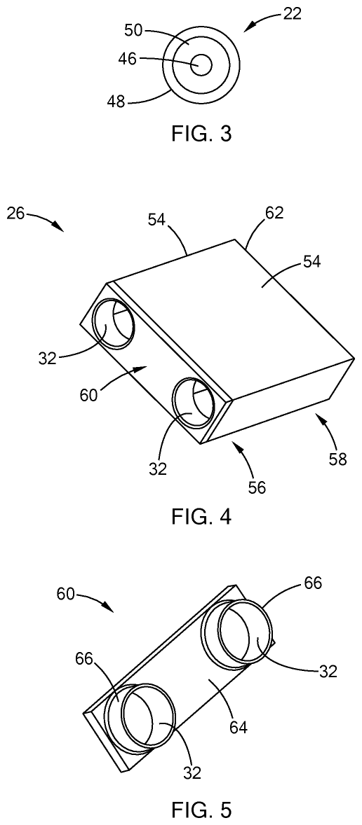

Referring to FIG. 3, the pair of heating sections 22 each include a resistive heating element 46, a sheath 48 surrounding the resistive heating element 46, and a dielectric material 50 disposed inside the sheath 48 to embed and electrically insulate the resistive heating element 46. The resistive heating elements 46 may be in one form of a resistive coil (not shown). The dielectric material 50 may be magnesium oxide (MgO) and is compacted around the resistive heating elements 46 within the sheath 48. Such a construction of heating elements, including the conventional hairpin bend as set forth above, is described in U.S. Pat. No. 9,113,501, which is commonly owned with the present application and the contents of which are incorporated herein by reference in its entirety.

The dielectric material 50 may be the same as or different from the dielectric material 30 inside the coupling enclosure 26 of the coupling assembly 24. In one form, both the dielectric materials 30 and 50 are MgO (magnesium oxide). However, it should be understood that a variety of insulating materials may be employed while remaining within the scope of the present disclosure.

Referring back to FIG. 2B, each of the heating sections 22 further include a conductive portion in the form of a conductive pin 52 connected to and extending from an end of the resistive heating element 46. As shown, a portion of the dielectric materials 50 surrounds the conductive pins 52 and is exposed from the sheath 48. The conductive pin 52 has an end portion exposed from the dielectric material 50 and the sheath 48 for contacting the coupling member 28. The coupling member 28 extends between and is in electrical contact with the conductive pins 52. In one form, the coupling member 28 is a copper material. In another form, the coupling member 28 is a nickel plated steel. The coupling member 28 thus provides an electrical connection between the conductive pins 52 and consequently between the resistive heating elements 48 of the heating sections 22. As the resistive heating elements 48 are a nickel alloy, the coupling member 28 is a different material than the resistive heating elements 48. However, the materials may be the same. As one example, the resistive heating elements 48 may have a cold pin (not shown) that is a nickel plated steel, and the coupling member 28 may also be a nickel plated steel.

In one form, the coupling member 28 is welded to the conductive pins 52 to provide a more robust connection for operating at higher voltages. As an example, the coupling member 28 may be in the form of a flat plate for supporting the conductive pins 52 thereon. While not shown in the drawings, it is understood that the conductive pins 52 may be secured to the coupling member 28 by any attachment means without departing from the scope of the present disclosure.

Therefore, the coupling member 28 may be used to replace a traditional hairpin, or 180° bend, coupled to the resistive heating elements such as those in a circulation heater. Replacing the typical hairpin or 180° bend with the coupling member 28 can increase the overall dielectric strength of the heater assembly 20 by eliminating the hairpin or 180° bend, or deformation of the resistive heating element 46. Typically, the hairpin or 180° bend portion of a typical heater is an integral part of the resistive heating element 46. By using a coupling member 28 as a separate component from the resistive heating elements 46 and having lower electric resistance and by increasing the amount of dielectric material 30 around the adjacent ends of the heating sections 22, the dielectric strength in the coupling assembly may be improved.

Referring to FIGS. 4 and 5, the coupling enclosure 26 includes a housing 54 having a proximal end portion 56 and a distal end portion 58, an element cap 60 disposed at a proximal end portion 56, and an end cap 62 disposed at the distal end portion 56. While the coupling enclosure 26 is shown to have a “box” shape, the coupling enclosure 26 may have any other configurations as long as the coupling enclosure 26 can enclose the exposed portions of the conductive pins 52, the coupling member 28, and the dielectric material 30 therein. The housing 54 may have a tubular shape or a rectangular shape and define opposing openings at the proximal end portion 56 and the distal end portion 58 along a direction parallel to the longitudinal directions of the heating sections 22. The element cap 60 and the end cap 62 are connected to the opposing ends of the housing 54 to close the opposing openings of the housing 54.

As clearly shown in FIG. 5, the element cap 60 includes a plate portion 64 defining the pair of apertures 32 and a pair of flanges 66 disposed along peripheries of the apertures 32 and extending along a direction parallel to a central axis of the aperture 32. The flanges 66 may be extruded or machined to provide cylindrical surfaces to surround the sheaths 48 of the heating section 22 when the heating sections 22 are inserted into the apertures 32. The heating sections 22 are welded to the element cap 60 by welding the sheaths 48 of the heating section 22 to the cylindrical surfaces of the flanges 66. The element cap 60 may be a separate component from the housing 54. After the heating sections 22 are welded to the element cap 60, the element cap 60 may be welded to the housing 54. Alternatively, the element cap 60 may be combined with the housing 54 as a single integrated component to reduce the number of components and welds. It should be understood that welding is merely one example of a joining technique and thus other techniques/materials (such as by way of example adhesive bonding) may be employed while remaining within the scope of the present disclosure.

Referring back to FIG. 2B, the apertures 32 and the flanges 66 allow ends of the heating sections 22 to be inserted therein such that the sheaths 48 of the heating sections 22 contact the cylindrical surfaces of the flanges 66 of the element cap 60. In one form, the sheaths 48 of the heating sections 22 may be welded to the flanges 66 of the element cap 60 to form a sealed interface/structure between the heating sections 22 and the element cap 60. In another form, a sealing member (not shown), such as an O-ring, may be disposed between each of the sheaths 48 of the heating sections 22 and a corresponding one of the flanges 66 of the element cap 60. This sealed interface/structure can also provide a pressure boundary for applications such as a fluid circulation heater. The element cap 60 may also be welded to the proximate end portion 56 of the housing 54 to form a sealed interface therebetween.

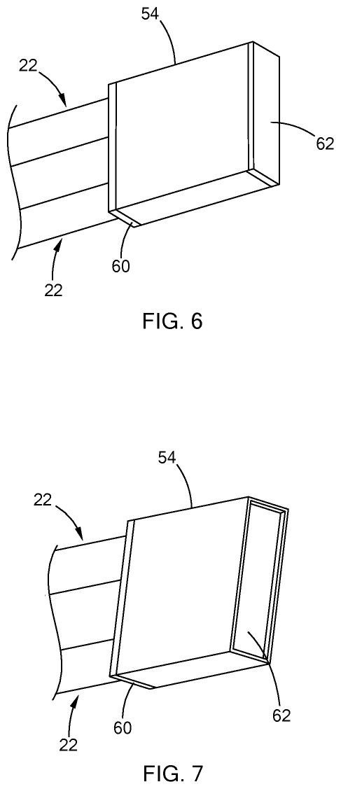

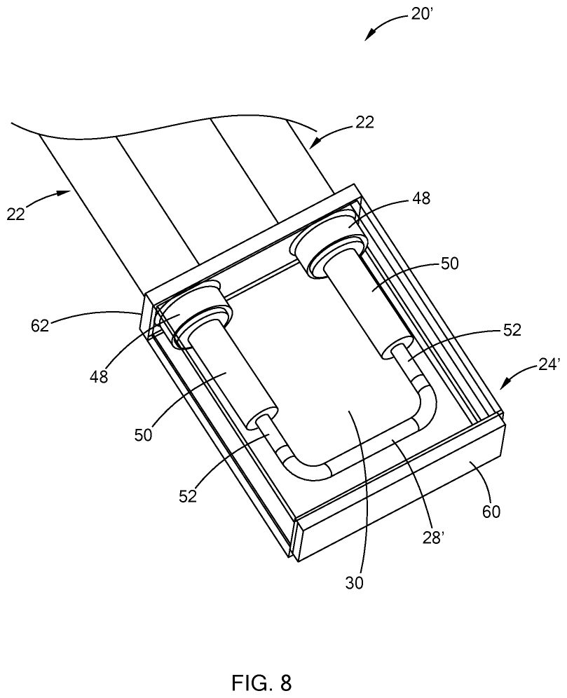

Referring to FIGS. 6 and 7, the end cap 62 may have a plate configuration and may be attached to the distal end portion 58 of the housing 54 opposing the element cap 60. The end cap 62 may be disposed outside the housing 54 as shown in FIG. 6 or may be recessed within the housing 54 as shown in FIG. 7. In either case, the end cap 60 may be welded to the housing 54. When the end cap 62 is recessed within the housing 54, the end cap 62 is made smaller than the housing 54 and is pushed inside the housing 54 during manufacturing to create a compressed dielectric material 30. After the dielectric material 30 is compressed and the end cap 62 is placed in position, the end cap 62 may then be welded to the housing 54 to close the housing 54.

It is understood that that the end cap 62 may have a configuration different from those shown in FIGS. 6 and 7 as long as it can be used to close the distal end portion 58 of the housing 54 and to provide a sealed interface, without departing from the scope of the present disclosure.

Referring to FIG. 8, a variant of a heater assembly 20′ constructed in accordance with the teachings of the present disclosure is structurally similar to the heater assembly 20 of FIG. 2A except for the configuration of the coupling assembly 24′ which includes a coupling member 28′ having a different configuration. Therefore, same or like reference numbers are used to designate same or like components and the description thereof is omitted for clarity. As shown, the coupling member 28′ may have a U-shape configuration or may be in the form of a circular bar, which is welded (e.g., butt-welded) to the conductive pins 52 of the heating sections 22.

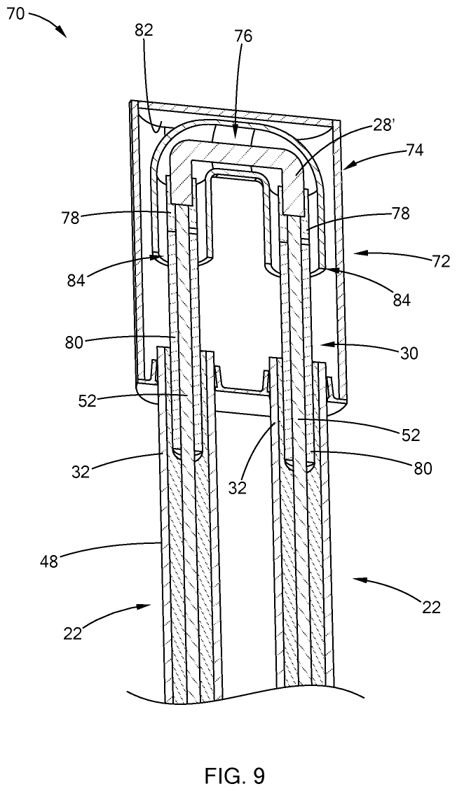

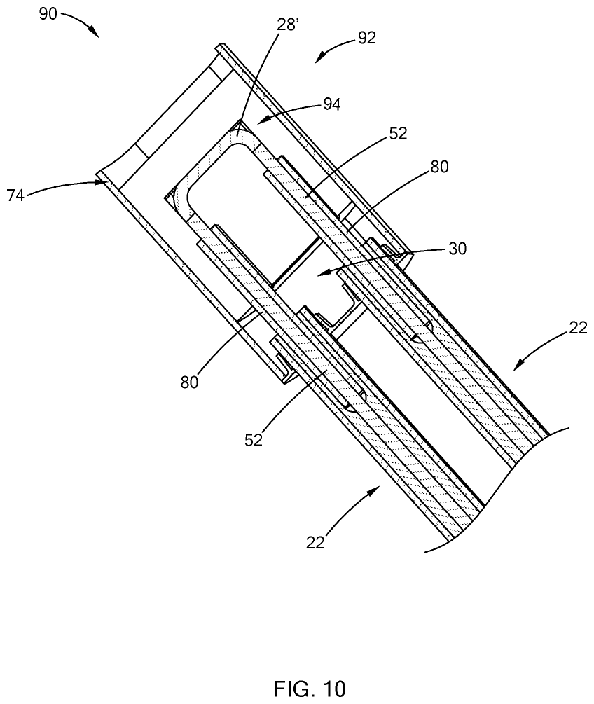

Referring to FIG. 9, another variant of a heater assembly 70 constructed in accordance with the teachings of the present disclosure is structurally similar to the heater assembly 20 of FIG. 2A and the heater assembly 20′ of FIG. 8 except for the configuration of the coupling assembly 72. Therefore, same or like reference numbers are used to designate same or like components and the description thereof is omitted for clarity.

More specifically, the coupling assembly 72 includes a coupling enclosure 74, a U-shaped dielectric member 76, a coupling member 28′ similar to that shown in FIG. 8 and received inside the U-shaped dielectric member 76, a pair of fittings 78 disposed inside the U-shaped dielectric member 76, a pair of tubular dielectric elements 80, and a dielectric material 30 disposed inside the coupling enclosure 74 and surrounding the U-shaped dielectric member 76 and the pair of tubular dielectric elements 80. The dielectric material 30 is similar to that shown in FIGS. 2A and 8 and can be a material the same as or different from that material of the U-shaped dielectric member 76 and the pair of tubular dielectric elements 80.

The U-shaped dielectric member 76 has a solid U-shape body defining a U-shape receiving space 82 and a pair of openings 84 at its free ends. The coupling enclosure 74 defines a pair of apertures 32 similar to those shown in FIG. 2A and aligned with the openings 84 of the U-shape dielectric member 76. By inserting the conductive pins 52 of the heating sections 22 into the apertures 32 of the coupling enclosure 74 and the openings 84 of the U-shaped dielectric member 76, the conductive pins 52 of the heating sections 22 can engage the coupling member 28′ inside the U-shaped dielectric member 76. The pair of fittings 78 are disposed inside the U-shaped dielectric member 76 proximate the free ends of the coupling member 28′. The conductive pins 52 of the heating sections 22 are press-fit into engagement with the coupling member 28′ with the fittings 78. Therefore in one form, the heating sections 22 can be coupled to the coupling assembly 72 by press-fit, rather than by welding.

The pair of tubular dielectric elements 80 are configured to be inserted into the apertures 32 of the coupling enclosure 74 and the openings 84 of the U-shaped dielectric member 76 to surround and electrically insulate the conductive pins 52 of the heating sections 22. A portion of the pair of tubular dielectric elements 80 is disposed inside the sheaths 48 of the heating sections 22. Like the heater assembly 20 of FIG. 2A and heater assembly 20′ of FIG. 8, the sheaths 48 of the heating sections 22 are also inserted into the apertures 32 of the coupling enclosure 74 and welded to the coupling enclosure 74 to provide a sealed interface. The U-shaped dielectric member 76, the dielectric material 30 filled inside the coupling enclosure 74, and the tubular dielectric elements 80 may include the same or different dielectric materials.

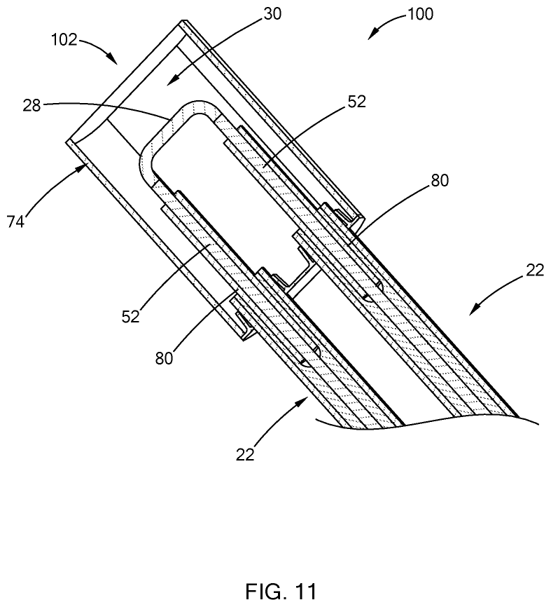

Referring to FIG. 10, another variant of a heater assembly 90 constructed in accordance with the teachings of the present disclosure is structurally similar to the heater assembly 70 of FIG. 9 differing in that the coupling assembly 92 includes a dielectric member 94 having a different configuration and the pair of fittings are eliminated. Therefore, same or like reference numbers are used to designate same or like components and the description thereof is omitted for clarity.

As shown, the coupling assembly 92 includes a dielectric member 94 in the form of a solid block for receiving the coupling member 28′ therein. The dielectric member 94 defines a U-shaped receiving space for receiving the coupling member 28′ and the pair of tubular dielectric elements 80. The free ends of the coupling member 28′ are welded to the conductive pins 52 of the heating sections 22. The coupling member 28′ may be made of the same material of the conductive pins 52 of the heating sections 22, or of a different material (having a higher or lower resistivity) to tailor the power density around the U-shaped coupling member 28′. The U-shaped receiving space of the dielectric member 94 has a shape conforming to an outer profile of the coupling member 28′, the conductive pins 52 and the tubular dielectric elements 80 such that the coupling member 28′, the conductive pins 52 and the tubular dielectric elements 80 can snugly fit into the U-shaped receiving space of the dielectric member 94.

Referring to FIG. 11, another variant of a heater assembly 100 constructed in accordance with the teachings of the present disclosure is structurally similar to the heater assemblies 70, 90 of FIGS. 9 and 10, differing in that the coupling assembly 102 does not include a dielectric member in solid form. In this form, the coupling member 28′ is welded to the conductive pins 52 of the heating sections 22. The coupling member 28′ and the conductive pins 52 of the heating sections 22 are directly embedded in a dielectric material 30 that fills in the space of the coupling enclosure 74. Similarly, the coupling assembly 102 includes a pair of tubular dielectric elements 80 surrounding the conductive pins 52 to electrically insulate the conductive pins 52 inside the coupling enclosure 74, as well as the portion of the conductive pins 52 proximate the apertures 32 of the enclosure 74.

In any one of the embodiments described above, the coupling enclosure 26, 74 enclose the coupling members 28, 28′ and the conductive pins 52 of the heating sections 22. The dielectric material 30 is disposed within the coupling enclosure 26 and surrounds the conductive pins 52 and the coupling member 28. The dielectric material 30 isolates the conductive pins 52 of the heating sections 22 and the coupling member 28 from the coupling enclosure 26 and its other components. In the heater assemblies 70, 90 of FIGS. 9 and 10, an additional dielectric member 74, 94, which is pre-formed to have a solid U-shape or block configuration, is used to further insulate the coupling member 28′ and the interface between the coupling member 28′ and the conductive pins 52. In the heater assemblies 70, 90, 100, a pair of tubular dielectric elements 80 are additionally used to insulate the portions of the conductive pins 52 proximate the apertures 32 of the coupling enclosure 74.

Although only two heating sections 22 and one coupling assembly 24 are illustrated and described, it should be understood that a plurality of heating sections 22 and a plurality of coupling assemblies 24, 72, 92, 102 may be employed to define a serpentine configuration while remaining within the scope of the present disclosure. Further, the coupling members 28, 28′ may take on any number of shapes other than the flat configuration or the circular pin as illustrated herein. For example, the coupling member 28, 28′ may include locating features such as slots or grooves for the conductive pins 52 and may wrap at least partially around the conductive pins 52.

In the heater assemblies 20, 20′, 70, 90, 100 of the present disclosure, the coupling assemblies 24, 24′, 72, 92, 102 may be used to replace a traditional 180° bend or a hairpin portion and can provide a high dielectric strength. The coupling assemblies 24, 24′, 72, 92, 102 provide a pressure boundary isolated connection between the heating sections 22 without the use of 180° bend.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. For example, one or more dielectric materials may be used within the various enclosures of the present disclosure. Such variations are not to be regarded as a departure from the spirit and scope of the disclosure.

1. A heater assembly comprising:
a pair of heating sections, each heating section including a conductive portion; and
a coupling assembly including a coupling enclosure and a coupling member disposed inside the coupling enclosure,
wherein the conductive portions of the pair of heating sections are connected by the coupling member inside the coupling enclosure.

2. The heater assembly according to claim 1, wherein the coupling enclosure defines a pair of apertures, the conductive portions being inserted into the pair of apertures to contact the coupling member.

3. The heater assembly according to claim 2, wherein the coupling assembly further includes a dielectric material disposed inside the coupling enclosure for electrically insulating the coupling member.

4. The heater assembly according to claim 1, wherein the pair of heating sections each include a resistive heating element, a sheath surrounding the resistive heating element, and a first dielectric material disposed inside the sheath, wherein the conductive portion extends from the resistive heating element and is exposed from the sheath and the first dielectric material.

5. The heater assembly according to claim 4, wherein the sheaths of the pair of heating sections are welded to the coupling enclosure.

6. The heater assembly according to claim 5, wherein a part of the sheath of each of the pair of heating sections is disposed inside the coupling enclosure.

7. The heater assembly according to claim 6, further comprising a sealing structure between the sheath of each of the pair of heating sections and the coupling enclosure.

8. The heater assembly according to claim 4, wherein the coupling member is made of a material different from that of the resistive heating elements.

9. The heater assembly according to claim 1 wherein the coupling enclosure comprises:
a housing comprising a proximal end portion and a distal end portion;
an element cap disposed at the proximal end portion and having two apertures, each of the pair of heating sections extending through one of the two apertures; and
a coupling cap secured to the distal end portion of the housing.

10. The heater assembly according to claim 9, wherein the element cap is welded to the pair of heating sections to form a sealed interface.

11. The heater assembly according to claim 10, wherein the element cap further comprises a flange extending from and surrounding each of the two apertures, the flange contacting an adjacent one of the heating sections.

12. The heater assembly according to claim 11, wherein the sheath of each of the pair of heating sections is welded to one of the flanges.

13. The heater assembly according to claim 9, wherein the housing and the element cap form a single integral part.

14. The heater assembly according to claim 1, wherein the conductive portions are welded to the coupling member.

15. The heater assembly according to claim 1, wherein the heating sections operate at voltages greater than about 480 volts.

16. A heater assembly comprising:
two heating sections, each heating section including a resistive heating element, a sheath surrounding the resistive heating element, a first dielectric material disposed inside the sheath, and a conductive pin extending from the resistive heating element and exposed from the sheath and the first dielectric material; and
a coupling assembly including:
a coupling enclosure;
a coupling member disposed inside the coupling enclosure and contacting the conductive pins of the two heating sections; and
a second dielectric material disposed inside the coupling enclosure and electrically insulating the coupling member and the conductive pins,
wherein the sheaths of the heating sections are welded to the coupling enclosure to form a sealed interface between the heating sections and the coupling enclosure.

17. The heater assembly according to claim 16, wherein the two heating sections operate at voltages greater than about 480 volts.

18. A coupling assembly for use in a heater system operating at voltages greater than about 480 volts, the coupling assembly comprising:
a coupling enclosure defining a pair of apertures for receiving conductive portions of a pair of heating sections;
a coupling member disposed inside the coupling enclosure for connecting the conductive portions of the pair of heating sections; and
a dielectric material disposed inside the coupling enclosure for electrically insulating the coupling member and the conductive portions of the heating sections.

19. The coupling assembly according to claim 18, wherein the coupling enclosure includes an element cap defining the pair of apertures, the heating sections being welded to the element cap around the apertures.

20. The coupling assembly according to claim 18, further comprising a sealing structure between the heating sections and the coupling enclosure along peripheries of the apertures.

21. The coupling assembly according to claim 18, wherein the coupling member has a plate configuration or a circular bar configuration.

22. The coupling assembly according to claim 18, wherein the dielectric material surrounds the conductive portions of the heating sections.
